(19) United States
(12) Patent Application Publication
(10) Pub. No.: US 2022/0185710 A1
(43) Pub. Date: Jun. 16, 2022

(54) WATER DISINFECTION DEVICE CONFIGURATIONS AND MATERIALS

(71) Applicant: EEnotech, Inc., Sunnyvale, CA (US)

(72) Inventors: Bofei Liu, Palo Alto, CA (US); Yuanqing Li, Santa Clara, CA (US); Yu Zhu, Sunnyvale, CA (US); Sidi Huang, San Jose, CA (US)

(21) Appl. No.: 17/117,935

(22) Filed: Dec. 10, 2020

(51) Int. Cl. C02F 1/48

(52) U.S. Cl. CPC C02F 1/48; C02F 2303/04; C02F 2301/026

(57) ABSTRACT

Water disinfection device configurations and materials are disclosed. In general, one aspect disclosed features an apparatus comprising: a water filtering module including: a rolled stack of sheets, the sheets comprising: an electrode sheet comprising a plurality of porous planar electrodes, a separator sheet comprising a porous planar separator, wherein the porous planar separator is disposed between at least two of the porous planar electrodes, and a perforated pipe extending longitudinally through a center of the rolled stack of sheets; and a case configured to house the rolled stack of sheets, and to direct water through the rolled stack of sheets.

### CROSS REFERENCE TO RELATED APPLICATIONS

The present application is related to U.S. patent application Ser. No. TBD, filed concurrently herewith, entitled “WATER DISINFECTION DEVICES AND METHODS”, Attorney Docket No. 63NL-320179, the disclosure thereof incorporated by reference herein in its entirety.

### BACKGROUND

The removal of bacteria and other harmful organisms from water is an important process, not only for drinking and sanitation but also industrially as biofouling is a commonplace and serious problem. Further, disinfecting challenge water presents a more difficult task. Challenge water generally contains suspended solids (SS), dissolved solids (DS), or other hard substances that need to be removed. Conventional methods for water sterilization suffer from certain deficiencies.

UV light can sanitize water to some degree. However, it is not effective in treating SS water. Ozone can be used to treat water, but potentially produce harmful byproducts in DS water, such as bromate. Chlorination is typically a slow process, involving incubation times up to an hour or more to allow chlorine species to adequately dissipate through water to be treated. Also, chlorination can yield hazardous oxidation byproducts, including carcinogenic species. Chlorination equipment can be capital intensive, both from the standpoint of deployment and maintenance. Chlorine can produce harmful byproducts in SS water, such as chloroform.

### SUMMARY

Described herein are apparatus and processes for disinfecting water or other liquid for drinking and industrial uses.

In general, one aspect disclosed features an apparatus comprising: a water filtering module including: a rolled stack of sheets, the sheets comprising: an electrode sheet comprising a plurality of porous planar electrodes, a separator sheet comprising a porous planar separator, wherein the porous planar separator is disposed between at least two of the porous planar electrodes, and a perforated pipe extending longitudinally through a center of the rolled stack of sheets; and a case configured to house the rolled stack of sheets, and to direct water through the rolled stack of sheets.

Embodiments of the apparatus may include one or more of the following features. Some embodiments comprise a power source configured to supply power to the at least two porous planar electrodes. In some embodiments, the case is configured to direct the water from an outside of the rolled stack of sheets, through the rolled stack of sheets, to the perforated pipe, and from the perforated pipe to an outlet of the case. In some embodiments, the case is configured to direct the water from an inlet of the case into the perforated pipe, from the perforated pipe through the rolled stack of sheets to an outside of the rolled stack of sheets, and then to an outlet of the case. In some embodiments, the perforated pipe has an inlet section configured to receive water entering an inlet of the case, and an outlet section to direct water to an outlet of the case; and the case is configured to direct the water from the inlet section of the perforated pipe through a first portion of the rolled stack of sheets to an outside of the rolled stack of sheets, then from the outside of the rolled stack of sheets through a second portion of the rolled stack of sheets into the outlet section of the perforated pipe. In some embodiments, the porous planar electrodes that are adjacent on the electrode sheet are disposed in separate layers of the rolled stack of sheets. In some embodiments, each of the porous planar electrodes includes an elongated pin configured to connect to a power source. In some embodiments, the elongated pins of porous planar electrodes that are adjacent on the electrode sheet are disposed on opposite sides of the electrode sheet. In some embodiments, the porous planar electrodes are made of titanium foil.

In general, one aspect disclosed features an apparatus comprising: a water filtering module including: a rolled stack of sheets, the sheets comprising: an electrode sheet comprising a plurality of planar electrodes, and a separator sheet comprising a planar separator, wherein the planar separator is disposed between at least two of the planar electrodes; and a case configured to house the rolled stack of sheets, and to direct water between the sheets in the rolled stack of sheets.

Embodiments of the apparatus may include one or more of the following features. Some embodiments comprise a power source configured to supply power to the planar electrodes. In some embodiments, the rolled stack of sheets is rolled in a spiral configuration, and the case is configured to direct water between the sheets in a spiral direction. In some embodiments, the case is configured to direct water between the sheets in a longitudinal direction. In some embodiments, the planar electrodes are made of titanium foil.

In general, one aspect disclosed features an apparatus comprising: a water filtering module including: a plurality of planar electrodes, and a case configured to retain the electrodes in parallel, and to direct water between the planar electrodes from an inlet of the case to an outlet of the case.

Embodiments of the apparatus may include one or more of the following features. Some embodiments comprise a power source configured to supply power to the plurality of planar electrodes. In some embodiments, planar electrodes are each made of at least one of: brass; bronze; copper; graphite; carbon felt; carbon mesh; titanium; stainless steel; platinum; or silicon.

In general, one aspect disclosed features an apparatus comprising: a water filtering module including: a first electrode comprising a plurality of first parallel blades, a second electrode comprising a plurality of second parallel blades, and a case configured to retain the electrodes such that the first parallel blades are interleaved with the second parallel blades, and to direct water between the first and second parallel blades.

Embodiments of the apparatus may include one or more of the following features. Some embodiments comprise a power source configured to supply power to the first and second electrodes. In some embodiments, the first electrode is a first folded sheet; and the second electrode is a second folded sheet. In some embodiments, the first and second electrodes are each made of at least one of: brass; bronze; copper; graphite; carbon felt; carbon mesh; titanium; stainless steel; platinum; or silicon. In some embodiments, each of the planar electrodes is disposed within a respective frame, and the frames are stacked to form a stack. In some embodiments, each of the planar electrodes is molded within a respective frame, and the frames are stacked to form a stack.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1A illustrates a stack of sheets for forming a rolled electrode configuration according to some embodiments of the disclosed technologies.

The electrodes may be arranged in pairs for connection to opposite polarities of a power source, as depicted in FIG. 1 B.

FIG. 2 is a cross-sectional view of a rolled stack of sheets according to some embodiments of the disclosed technologies.

FIG. 3 is a photograph of a rolled electrode configuration according to embodiments of the disclosed technologies.

FIG. 4 shows water may be directed longitudinally between the layers of the stack of sheets.

FIG. 5 shows water may be directed spirally between the sheets.

FIG. 6 is a schematic diagram illustrating a water disinfection apparatus according to a first embodiment of the disclosed technologies.

FIG. 7 is a schematic diagram illustrating a water disinfection apparatus according to a second embodiment of the disclosed technologies.

FIG. 8 is a schematic diagram illustrating a water disinfection apparatus according to a third embodiment of the disclosed technologies.

FIG. 9 is a schematic diagram illustrating a water disinfection apparatus according to a fourth embodiment of the disclosed technologies.

FIG. 10 is a schematic diagram illustrating a water disinfection apparatus according to a fifth embodiment of the disclosed technologies.

FIG. 11 is a schematic diagram illustrating a water disinfection apparatus according to a sixth embodiment of the disclosed technologies.

FIG. 12 is a schematic diagram illustrating a water disinfection apparatus according to a seventh embodiment of the disclosed technologies.

FIG. 13 is a schematic diagram illustrating a water disinfection apparatus according to an eighth embodiment of the disclosed technologies.

FIG. 14 illustrates the construction of a water disinfection apparatus 1400 according to a ninth embodiment of the disclosed technologies.

FIG. 15 illustrates an electrode unit according to some embodiments of the disclosed technologies.

FIG. 16 illustrates the construction of a water disinfection apparatus according to a tenth embodiment of the disclosed technologies.

FIG. 17 is a graph showing results of pressure drop testing for various flow rates and electrode forms.

### DETAILED DESCRIPTION OF EMBODIMENTS

In the following description, certain specific details are set forth in order to provide a thorough understanding of various embodiments of the invention. However, one skilled in the art will understand that the invention may be practiced without these details. Moreover, while various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

Various embodiments described herein are directed to an apparatus for disinfecting water and other liquids for drinking and industrial uses. The water filters may be modularized such that the capacity and ability to filter water can be easily expanded.

### EXAMPLE I

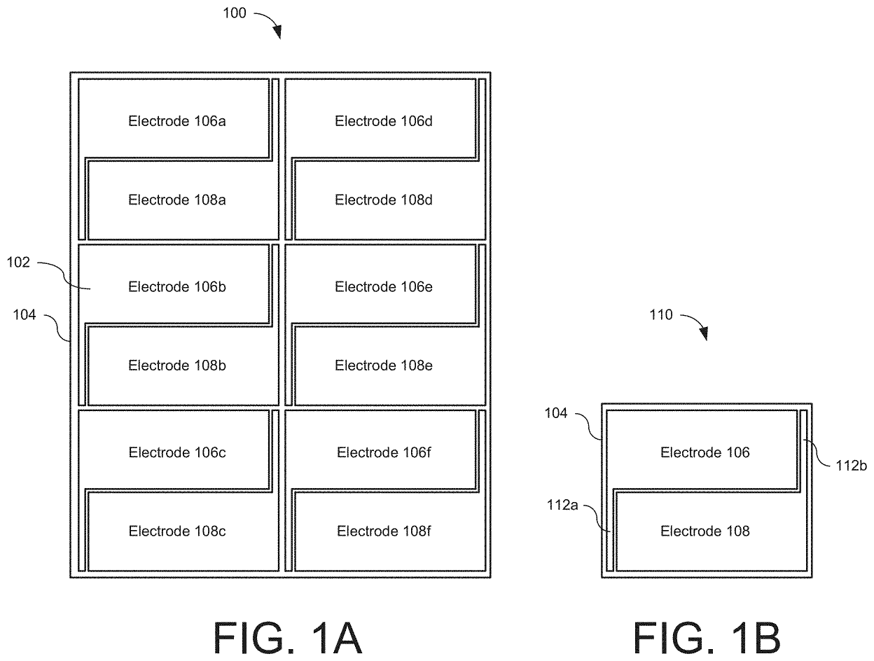

Embodiments will now be explained with the accompanying figures. Reference is made to FIG. 1A. FIG. 1A illustrates a stack of sheets 100 for forming a rolled electrode configuration according to some embodiments of the disclosed technologies. The stack of sheets 100 includes a sheet of electrodes 102. In the example of FIG. 1A, the electrodes include 8 electrodes 106a,b,c,d,e,f and 8 electrodes 108a,b,c,d,e,f. However, the sheet of electrodes 102 may include any number of electrodes 106,108.

The electrodes 106,108 may be arranged in pairs for connection to opposite polarities of a power source, as depicted in FIG. 1B. A sheet of electrodes 102 may be formed by stamping a sheet of electrode material. The electrode material may be, for example, titanium foil, copper foil and mesh, brass, bronze mesh and foil, carbon felt, carbon nanotubes, silver nanowires, graphite foil, other metal foams and sheets, or the like. The electrodes may be porous, non-porous, partially porous, and the like.

The sheet of electrodes 102 may be disposed upon a separator sheet 104. The separator sheet 104 may serve to separate the electrodes when the stack of sheets 100 is rolled. Any suitable non-conductive material may be used for the separator sheet 104. The separator sheet 104 may be porous, non-porous, partially porous, and the like.

The sheet of electrodes 102 may be divided prior to rolling. For example, referring to FIG. 1B, the sheet of electrodes 102 may be divided into multiple divided stacks of sheets 110 each comprising one pair of electrodes 106,108. However, the sheet of electrodes 102 may be divided in other ways.

The electrodes may be formed such that each electrode includes a pin for connection to a power source. In the example of FIG. 1B, the electrode 106 includes a pin 112a , and the electrode 108 includes a pin 112b . One advantage of this configuration lies in the fact that the pins are integral, so additional pins need not be added in a separate manufacturing step. The pairs of electrodes 106,108, with pins 112 may be formed in an interlocking pattern, as depicted. This arrangement serves to conserve material.

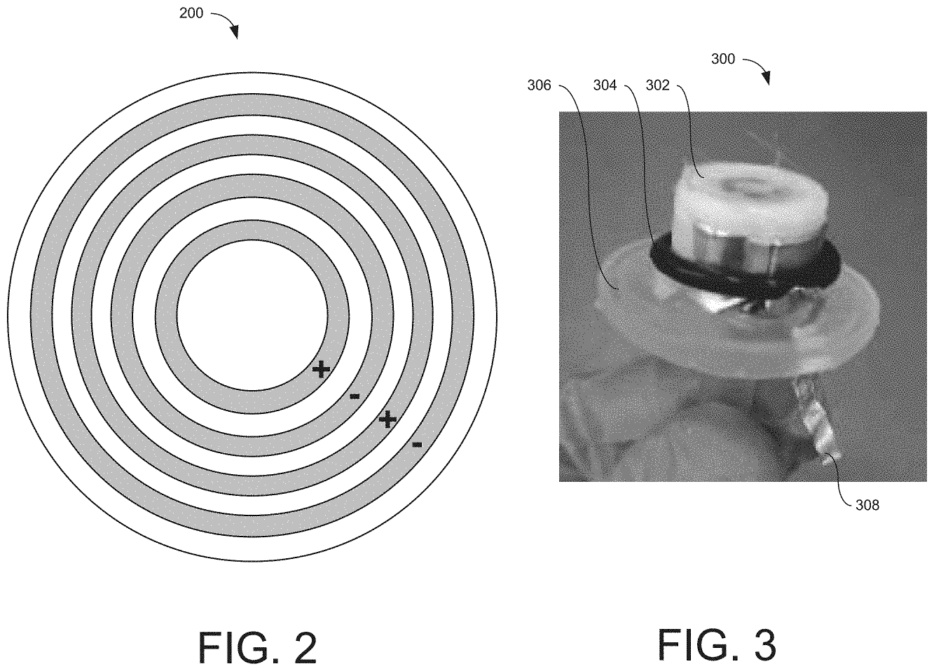

The divided stack of sheets 110 may be rolled into a cylinder having a diameter such that the separator sheet 104 separates the electrodes 106,108. In some embodiments, the rolled stack of sheets may form spirals of electrodes and separators. FIG. 2 is a cross-sectional view of a rolled stack of sheets 200 according to some embodiments of the disclosed technologies. In some embodiments, the rolled stack of sheets 200 may include concentric rings of alternating electrodes (marked + and − in FIG. 2), separated by rings of separator sheets, as depicted in FIG. 2. The polarities in FIG. 2 may be reversed.

FIG. 3 is a photograph of a rolled electrode configuration 300 according to embodiments of the disclosed technologies. The rolled electrode configuration 300 may include a rolled stack of sheets 302. The rolled stack of sheets 302 may be secured by a securing mechanism 304, such as an 0-ring or the like. The rolled stack of sheets 302 may be affixed to a baseplate 306 or the like. The electrode pins 308 may extend through openings in the baseplate 306, as shown in FIG. 3.

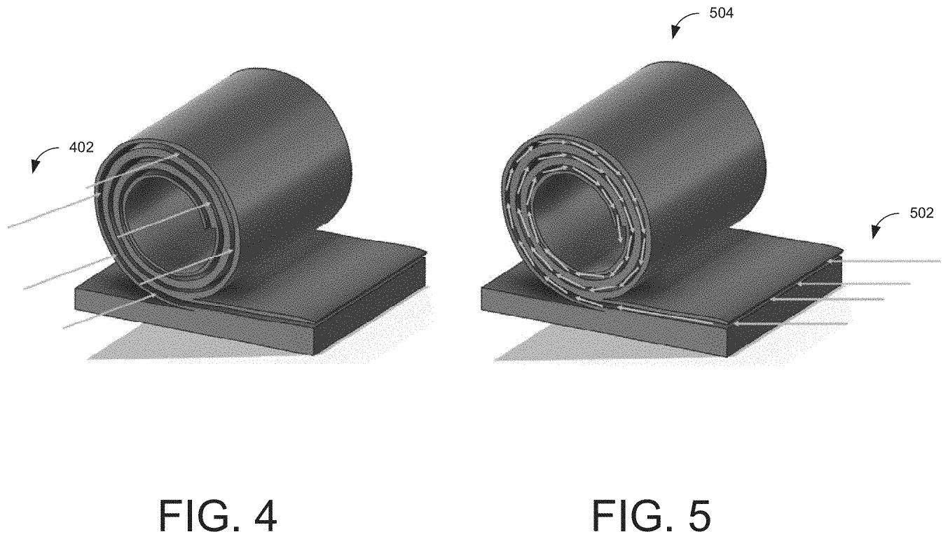

Water may be directed through the rolled stack of sheets in one or more ways. Referring to FIG. 4, water may be directed longitudinally between the layers of the stack of sheets, as indicated by the arrows at 402. Referring to FIG. 5, water may be directed spirally between the sheets, as indicated by the arrows at 502 and 504. Water may be directed through the sheets, from the outside to the center, or from the center to the outside. In various embodiments, these ways may be employed alone, or in any combination.

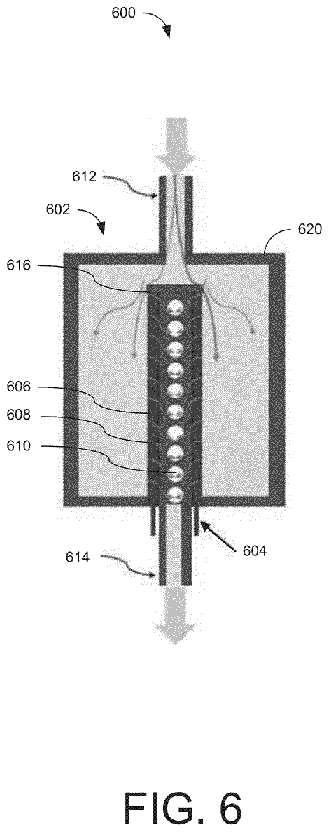

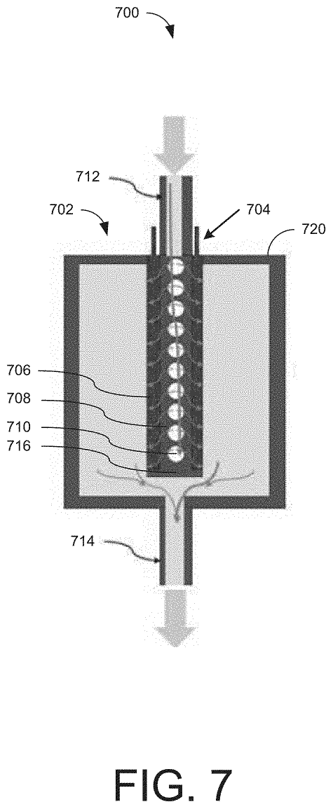

Reference is made to FIG. 6. FIG. 6 is a schematic diagram illustrating a water disinfection apparatus 600 according to a first embodiment of the disclosed technologies. The apparatus 600 includes a water filtering module 602. The water filtering module 602 may include a rolled stack of sheets 606 housed in a case 620. The rolled stack of sheets 606 may be formed as described above. Pins 604 of the electrodes may extend out of the case 620 for connection with a power supply.

Materials for the case 620 are selected such that the case 620 is water leakage-proof, resistant to water, safe to drink, durable, and of high mechanical strength. For example, the materials for the case 620 may be selected from a group containing silicone, plastics (e.g., ABS), rubber, and other suitable materials that have the above characteristics.

The case 620 may be formed by methods such as injection molding, insert molding, preforming, three-dimensional printing, computer numerical control (CNC) machining, and the like. The electrodes and separators may be sealed in the case 620 in any manner, for example including mechanical structures, such as threads, snaps, screws, etc., adhesives, glues, ultrasonic welding, and the like.

A perforated pipe 608 having one or more lateral holes 610 may be disposed inside the rolled stack of sheets 606. In this embodiment, the perforated pipe 608 may be connected to an outlet 614 of the case 620 but not to an inlet of the case 620, and may include a plug 616 at the inlet end to prevent water from entering the perforated pipe 608 directly. In this arrangement, water is directed into the interior of the case 620 through the inlet 612, and then passes through the rolled stack of sheets 606, through the holes 610 into the perforated pipe 608, and then out through the outlet 614.

During operation of the described embodiments, a voltage is applied across the pins as water is passed through the water disinfection apparatus, thereby disinfecting the water. This increases effectiveness in disinfecting water under treatment. For example, the connected power source may be tuned to provide suitable power to the electrodes depending on the water quality, the size, aging, materials of the electrodes and separators, and the like.

### EXAMPLE II

Reference is made to FIG. 7. FIG. 7 is a schematic diagram illustrating a water disinfection apparatus 700 according to a second embodiment of the disclosed technologies. The apparatus 700 includes a water filtering module 702. Elements of the water filtering module 702 may be similar to similar elements of the water filtering module 602 of FIG. 6 except where described differently.

The water filtering module 702 may include a rolled stack of sheets 706 housed in a case 720. Pins 704 of the electrodes may extend out of the case 720 for connection with a power supply.

A perforated pipe 708 having one or more lateral holes 710 may be disposed inside the rolled stack of sheets 706. In this embodiment, the perforated pipe 708 may be connected to an inlet 712 of the case 720 but not to an outlet 714 of the case 720, and may include a plug 716 at the outlet end to prevent water from leaving the perforated pipe 708 directly. In this arrangement, water is directed through the inlet 712 into the perforated pipe 708, and then passes through the holes 710 and the rolled stack of sheets 706 into the interior of the case 720, and then out through the outlet 714.

### EXAMPLE III

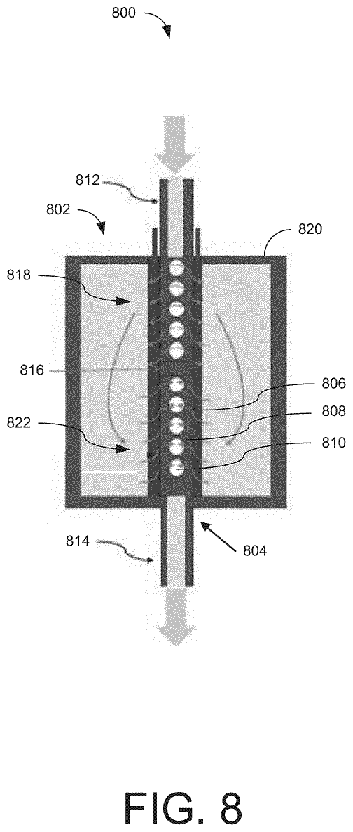

Reference is made to FIG. 8. FIG. 8 is a schematic diagram illustrating a water disinfection apparatus 800 according to a third embodiment of the disclosed technologies. The apparatus 800 includes a water filtering module 802. Elements of the water filtering module 802 may be similar to similar elements of the water filtering module 602 of FIG. 6 except where described differently.

The water filtering module 802 may include a rolled stack of sheets 806 housed in a case 820. Pins 804 of the electrodes may extend out of the case 820 for connection with a power supply.

A perforated pipe 808 having one or more lateral holes 810 may be disposed inside the rolled stack of sheets 806. In this embodiment, the perforated pipe 808 may be connected to both an inlet 812 of the case 820 and an outlet 814 of the case 820, and may include a plug 816 separating an inlet section 818 of the perforated pipe 808 from an outlet section 822 of the perforated pipe 808.

In this arrangement, water is directed through the inlet 812 into the inlet section 818 of the perforated pipe 808, and then passes through the holes 810 and the rolled stack of sheets 806 into the interior of the case 820. The water then passes from the interior of the case 820 through the rolled stack of sheets 806 and through the holes 810 into the outlet section 822 of the perforated pipe 808, and then out through the outlet 814. Note that in these embodiments, the water passes through the rolled stack of sheets 806 twice.

### EXAMPLE IV

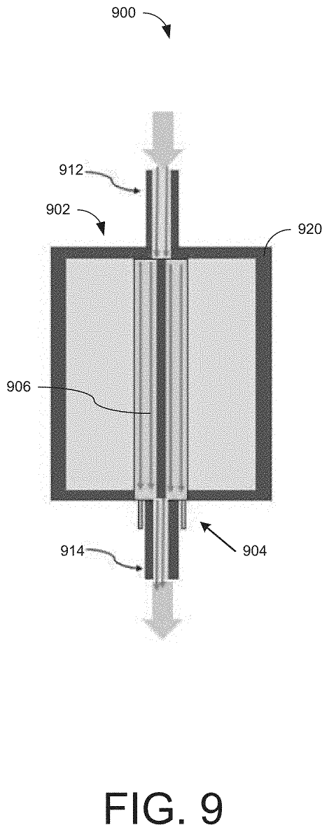

Reference is made to FIG. 9. FIG. 9 is a schematic diagram illustrating a water disinfection apparatus 900 according to a fourth embodiment of the disclosed technologies. The apparatus 900 includes a water filtering module 902. Elements of the water filtering module 902 may be similar to similar elements of the water filtering module 602 of FIG. 6 except where described differently.

The water filtering module 902 may include a rolled stack of sheets 906 housed in a case 920. Pins 904 of the electrodes may extend out of the case 920 for connection with a power supply.

In this embodiment, the rolled stack of sheets 906 may be connected to both an inlet 912 of the case 920 and an outlet 914 of the case 920. In this arrangement, water is directed through the inlet 912 into the rolled stack of sheets 906, passes between the sheets of the rolled stack of sheets 906 and over the electrodes, and then out through the outlet 914. In some embodiments, the rolled stack of sheets 906 may be porous or partially porous such that the water may flow through the rolled stack of sheets 906 into the interior of the case 920. In some embodiments, the rolled stack of sheets 906 may be non-porous such that water may flow through the rolled stack of sheets 906

### EXAMPLE V

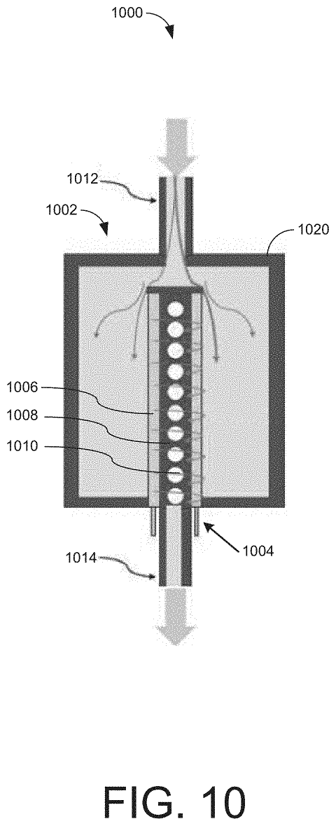

Reference is made to FIG. 10. FIG. 10 is a schematic diagram illustrating a water disinfection apparatus 1000 according to a fifth embodiment of the disclosed technologies. The apparatus 1000 includes a water filtering module 1002. Elements of the water filtering module 1002 may be similar to similar elements of the water filtering module 602 of FIG. 6 except where described differently.

The water filtering module 1002 may include a rolled stack of sheets 1006 housed in a case 1020. In this embodiment, water may be directed spirally between the sheets, as in the embodiment of FIG. 5. Pins 1004 of the electrodes may extend out of the case 1020 for connection with a power supply.

A perforated pipe 1008 having one or more lateral holes 1010 may be disposed inside the rolled stack of sheets 1006. In this embodiment, the perforated pipe 1008 may be connected to an outlet 1014 of the case 1020 but not to an inlet of the case 1020, and may include a plug 1016 at the inlet end to prevent water from entering the perforated pipe 1008 directly. In this arrangement, water is directed into the interior of the case 1020 through the inlet 1012, and then passes spirally between the rolled stack of sheets 1006, through the holes 1010 into the perforated pipe 1008, and then out through the outlet 1014.

### EXAMPLE VI

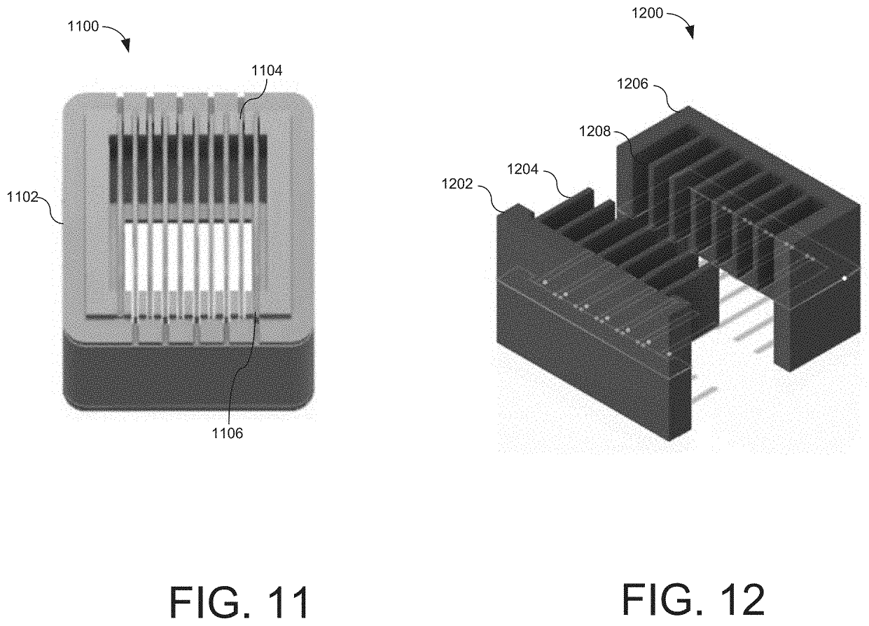

Reference is made to FIG. 11. FIG. 11 is a schematic diagram illustrating a water disinfection apparatus 1100 according to a sixth embodiment of the disclosed technologies. The apparatus 1100 includes a plurality of planar electrodes 1104,1106 disposed within a cage 1102. The electrodes may be connected to a power source such that polarities of the electrodes alternate. For example, the electrodes 1104 may be connected to a positive polarity of the power source, while the electrodes 1106 may be connected to a negative polarity. The water disinfection apparatus 1100 may be disposed in a case configured to direct water through the cage 1102 and between the electrodes 1104,1106. The electrode materials may include, for example, titanium, brass, bronze, copper, carbon felt, graphite foil, carbon nanotube, graphite felt, copper sheet, silicon, Ti/Pt, RuO2/IrO2 doped Ti, platinum, and the like, and combinations thereof.

### EXAMPLE VII

Reference is made to FIG. 12. FIG. 12 is a schematic diagram illustrating a water disinfection apparatus 1200 according to a seventh embodiment of the disclosed technologies. The apparatus 1200 may include a first electrode 1202 comprising a plurality of first parallel blades 1204, and a second electrode 1206 comprising a plurality of second parallel blades 1208. The electrodes 1202,1206 may be formed by casting the electrode material in molds. The electrode materials may include, for example, titanium, brass, bronze, copper, carbon felt, graphite foil, carbon nanotube, graphite felt, copper sheet, and silicon, and the like, and combinations thereof.

The apparatus 1200 may include a case configured to retain the electrodes 1202,1206 such that the first parallel blades 1204 are interleaved with the second parallel blades 1208, and to direct water between the first and second parallel blades 1204,1208.

### EXAMPLE VIII

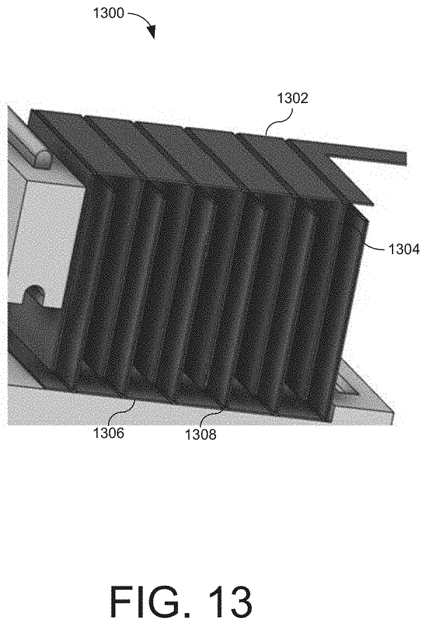

Reference is made to FIG. 13. FIG. 13 is a schematic diagram illustrating a water disinfection apparatus 1300 according to an eighth embodiment of the disclosed technologies. The apparatus 1300 may include a first electrode 1302 comprising a plurality of first parallel blades 1304, and a second electrode 1306 comprising a plurality of second parallel blades 1308. Each of the electrodes 1302,1206 may be formed by folding a single sheet of electrode material. The electrode materials may include, for example, titanium, brass, bronze, copper, carbon felt, graphite foil, carbon nanotube, graphite felt, copper sheet, silicon, Ti/Pt, RuO2/IrO2 doped Ti, platinum, and the like, and combinations thereof.

The apparatus 1300 may include a case configured to retain the electrodes 1302,1306 such that the first parallel blades 1304 are interleaved with the second parallel blades 1308, and to direct water between the first and second parallel blades 1304,1308. The electrode materials may include, for example, titanium, brass, bronze, copper, carbon felt, graphite foil, carbon nanotube, graphite felt, copper sheet, and silicon, and the like, and combinations thereof.

### EXAMPLE IX

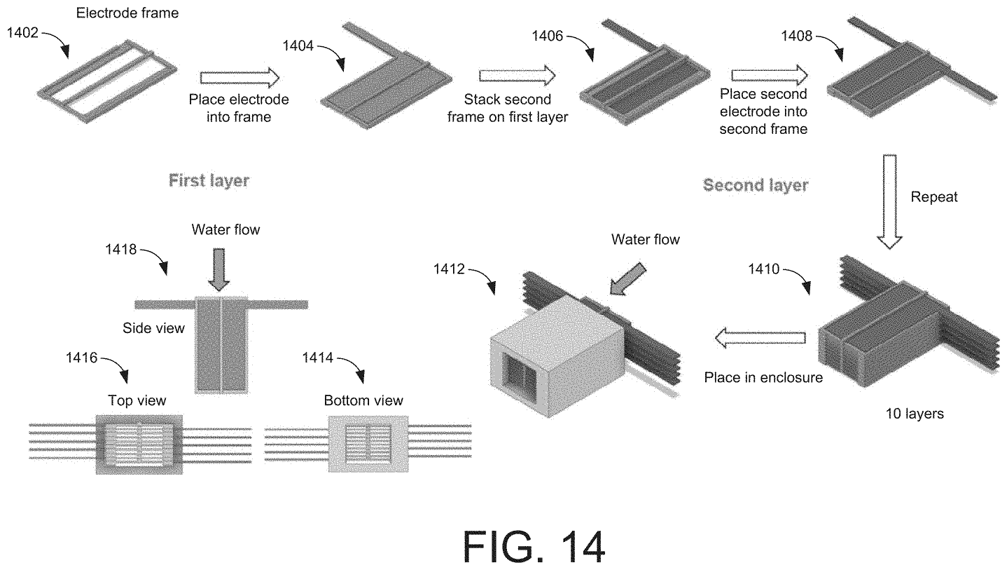

Reference is made to FIG. 14. FIG. 14 illustrates the construction of a water disinfection apparatus 1400 according to a ninth embodiment of the disclosed technologies. The construction may begin with providing an electrode frame, as shown at 1402. The electrode frame may be made of a non-conductive material. Next an electrode may be placed into the frame, as shown at 1404. The electrode may be made as discussed above with reference to FIGS. 1 A and 1 B. In the example of FIG. 14, the electrode may be made of titanium, brass, bronze, copper, carbon felt, graphite foil, carbon nanotube, graphite felt, copper sheet, and silicon, and the like.

Next, a second electrode frame may be stacked upon the first frame and electrode, as shown at 1406. Then a second electrode may be placed into the second frame, as shown at 1408. The steps 1406 and 1408 may be repeated, as shown at 1410. In the depicted embodiment, the stack has 10 electrodes and 10 frames. In other embodiments, the stack may have other numbers of electrodes and frames.

The stack of frames and electrodes may be placed in a cage, as shown at 1412. Bottom and top views of the resulting assembly are shown at 1414 and 1416, respectively. The direction of water flow is shown at 1418.

### EXAMPLE X

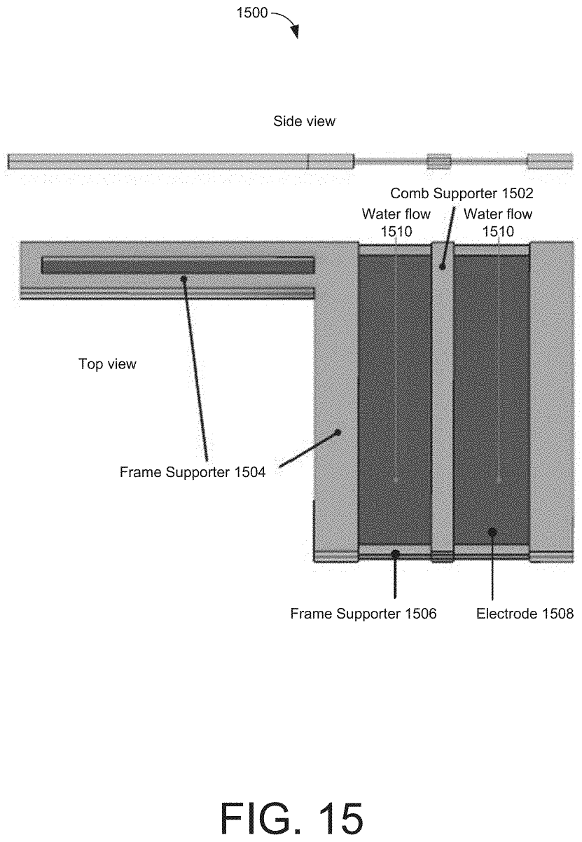

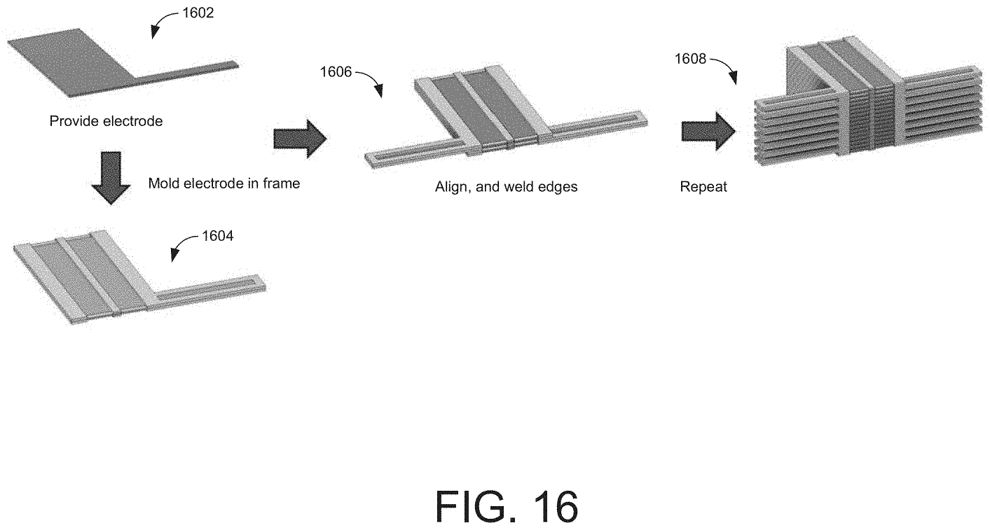

Reference is made to FIGS. 15 and 16. FIG. 15 illustrates an electrode unit 1500 according to some embodiments of the disclosed technologies. The electrode unit 1500 includes an electrode 1508 and a frame. The frame includes a comb supporter 1502, a first frame supporter 1504, and a second frame supporter 1506. The electrode 1508 may be formed by cutting a plate of the electrode material into the proper shape. The frame may then be molded about the electrode 1508 to form the electrode unit 1500. The direction of water flow is shown at 1510.

The comb supporter 1502 may separate the electrodes so the electrodes do not contact each other, thereby preventing electrical shorts. The frame supporter 1506 fully covers the edges of the electrode 1508 to protect it from debris and water flow damage. When stacking the plates together, the frame supporter 1506 also protects the users fingers, as well as the filter, from the sharp edges of the electrode 1508.

These embodiments provide several advantages. It is not necessary to insert the electrode into the frame. The electrode will not bend or shift within the frame. The gap between the electrodes is well-defined. There is no debris after die cutting. The electrode unit is a single unit that can be packaged and ready for stacking.

In some embodiments, the electrode unit 1500 may have the dimensions that follow. The electrode 1508 may be 0.4 mm thick. The comb supporter 1502 and the frame supporter 1504 may be approximately 1 mm in thickness. The frame supporter 1504 may be approximately 1 mm in thickness, providing a gap of approximately 0.6 mm to permit water flow. Other embodiments may have different dimensions.

FIG. 16 illustrates the construction of a water disinfection apparatus 1400 according to a tenth embodiment of the disclosed technologies. The construction may begin with providing an electrode such as the electrodes described herein, as shown at 1602. Next a frame may be molded about the electrode to form an electrode unit, as shown at 1604. Next two of the electrode units may be stacked and aligned, and the edges of the frames welded together, for example by ultrasonic welding, as shown at 1606. The steps 1602, 1604, and 1606 may be repeated to form a stack, as shown at 1608. The stack may have any number of electrode units. The stack may be placed in a cage, for example as described above.

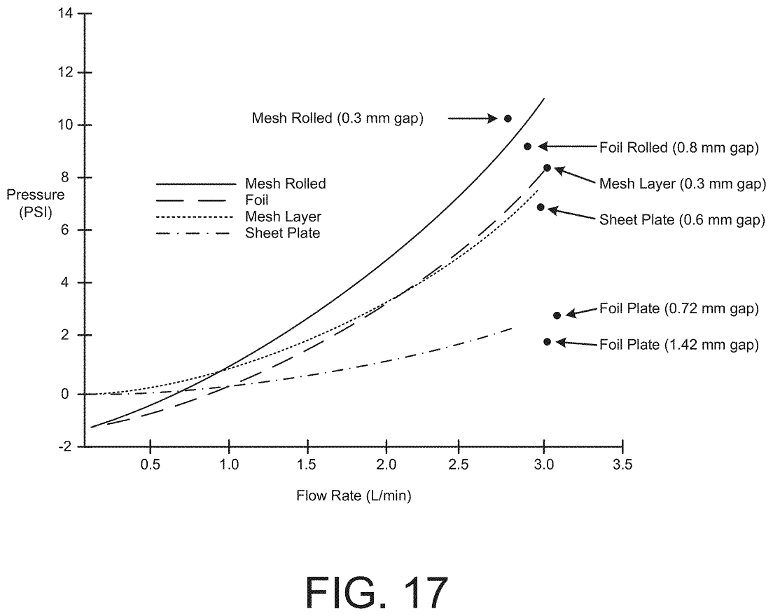

FIG. 17 is a graph showing results of pressure drop testing for various flow rates and electrode forms. The pressure drop represents the reduction in pressure of water passed through the electrode material. As can be seen in FIG. 17, the pressure drop is greatest for foil in a rolled configuration, followed by mesh in a mesh configuration, sheet in a plate configuration, and foil in a plate configuration.

Various electrode materials have been described for various embodiments, and may be chosen to suit the desired application. These materials may be employed alone or in combination. The electrode materials may be processed or non-processed. The processing may include oxidation, acid washing, doping, coating, and the like. As noted above, the electrodes may be porous, nonporous, or partially porous.

The electrode materials may be of various material forms. For example, the material forms may include, meshes, foams, papers, foils, sheets, plates, ingots, molded ones, surface modified, and the like, and combinations thereof. The electrodes may be of various thicknesses, which may be selected to suit the application.

In some embodiments, the electrode materials may include stainless steel foils and sheets, copper foils and sheets, Ti/Pt, RuO2/IrO2 doped Ti, brass, bronze, platinum, and the like. In some embodiments, the electrode materials may include non-metal materials. For example, the non-metal materials may include carbon felt, carbon mesh, activated carbon, graphite sheets, graphite foils, silicon wafers, and the like. Benefits of non-metal materials include high electrical conductivity, low costs, and wide availability.

Table 1 presents example disinfection results for the rolled stack of sheets and plate configurations, for flow rates of 0.5 L/min, 1.5 L/min, and 3.0 L/min. Disinfection results are excellent for all configurations. The number in the “Replicates” column indicates the test number. For example, in Table 1, results are provided for two tests for each structure .

TABLE 1

| | | Repli- | Disinfection Results | | |
|---|---|---|---|---|---|
| Structure | Material | cates | 0.5 L/min | 1.5 L/min | 3.0 L/min |
| Rolled | Metal- | #1 | 100.0000% | 100.0000% | 100.0000% |
| | based | #2 | 100.0000% | 100.0000% | 100.0000% |
| | Material | | | | |
| | #1 | | | | |
| Plate | Metal- | #1 | 100.0000% | 100.0000% | 100.0000% |
| | based | #2 | 100.0000% | 100.0000% | 99.9800% |
| | Material | | | | |
| | #1 | | | | |

Table 2 presents example disinfection results for the plate configuration for various materials, for flow rates of 0.5 L/min, 1.5 L/min, and 3.0 L/min. Disinfection results are excellent for all configurations.

TABLE 2

| | | Repli- | Disinfection Results(%) | | |
|---|---|---|---|---|---|
| Structure | Material | cates | 0.5 L/min | 1.5 L/min | 3.0 L/min |
| Plate | Metal- | #1 | 100.0000 | 100.0000 | 100.0000 |
| | based | #2 | 100.0000 | 100.0000 | 99.9800 |
| | Material | | | | |
| | #1 | | | | |
| | Carbon- | #1 | 100.0000 | 100.0000 | 100.0000 |
| | based | #2 | 100.0000 | 100.0000 | 100.0000 |
| | Material | | | | |
| | #1 | | | | |
| | Material | #1 | 100.0000 | 100.0000 | 100.0000 |
| | #3 | #2 | 100.0000 | 100.0000 | 100.0000 |

Table 3 presents soak leaching results for metal- and carbon-based materials, for exposure water of pH=8, hardness=100 mg/L, and free chlorine of 2 mg/L, for one piece of material in the exposure water with a ratio of 500 cm²/L. It can be seen that metal-based material has some metal leaching, while carbon-based material has none. Both materials meet safety requirements for various applications, including drinking water, industrial waste water, and the like.

TABLE 3

| | | | Metal Increment (C₂₄ₕ-C₀)/ppb | | | | |
|---|---|---|---|---|---|---|---|
| Material/ | | Repli- | Ni | Cu | Zn | Pb | Cr |
| Thickness | Process | cates | (<2) | (<200) | (<2) | (<1) | (<5) |
| Metal- | None | #1 | 0 | 276.9 | 1.4 | 0.9 | 0 |
| based | #1 | #2 | 0.2 | 248.8 | 0.9 | 0.8 | 0 |
| Material | #2 | #3 | 0.3 | 139.6 | 0.6 | 0.6 | 0 |
| 0.08 mm | | | | | | | |
| Carbon- | None | #1 | 0 | 0 | 0 | 0.1 | 0 |
| based | | #2 | 0 | 4.3 | 0 | 0 | 0 |
| Material | | #3 | 0 | 3.0 | 0 | 0 | 0 |
| #1 | | | | | | | |

Table 4 presents example disinfection results for a carbon-based material and a non-metal based material for various water qualities.

TABLE 4

| | Water | Disinfection Results(%) | | |
|---|---|---|---|---|
| Material | Comp. | 0.5 L/min | 1.5 L/min | 3.0 L/min |
| Carbon-based | 100 ppm | 100.0000 | 99.9996 | 99.9996 |
| Material #1 | NaHCO₃ + | 100.0000 | 100.0000 | 100.0000 |
| | 100 ppm | | | |
| | CaCl₂ | | | |
| | 134 ppm | 100.0000 | 100.0000 | 100.0000 |
| | NaHCO₃ + | 100.0000 | 100.0000 | 100.0000 |
| | 158 ppm | | | |
| | CaCl₂ | | | |
| | 269 ppm | 100.0000 | 100.0000 | 100.0000 |
| | NaHCO₃ + | | | |
| | 277 ppm | | | |
| | CaCl₂ | | | |
| | 680 ppm | 100.0000 | 100.0000 | 100.0000 |
| | NaHCO₃ + | | | |
| | 550 ppm | | | |
| | CaCl₂ | | | |
| Non-metal based | 100 ppm | 99.9956 | | |
| Material | NaHCO₃ + | | | |
| | 100 ppm | | | |
| | CaCl₂ | | | |
| | 134 ppm | 99.9977 | 99.9916 | |
| | NaHCO₃ + | 100.0000 | | |
| | 158 ppm | | | |
| | CaCl₂ | | | |

Table 5 presents example instant kill results for different materials and voltages, and water types, for flow rates of 0.5 L/min, 1.5 L/min, and 3.0 L/min. Instant kill refers to real-time disinfection, without waiting times. In Table 5 the target water is 134 ppm NaHCO₃+158 ppm CaCI₂. A disinfection result of 100.0% indicates there is no live bacteria after disinfection.

TABLE 5

| | Water | Disinfection Results | | |
|---|---|---|---|---|
| Material/Voltage | Comp. | 0.5 L/min | 1.5 L/min | 3.0 L/min |
| Carbon-based | 10 ppm NaCl | 100.0000% | 99.9333% | |
| Material | 100 ppm NaCl | 100.0000% | 99.9206% | 99.9987% |
| 20 V AC | | | | |
| Carbon-based | 134 ppm | 99.9989% | 99.9955% | |
| Material | NaHCO₃ + | | | |
| 10 V DC | 158 ppm | | | |
| | CaCl₂ | | | |

As shown in Table 5, carbon-based material disinfection shows good instant kill results for various power signals (AC and DC) for various water types.

As described above, in some embodiments, the disclosed separators and electrodes may be porous. In such embodiments, the separators include a porous polymer or mesh that provide insulation between two adjacent porous electrodes. For example, the porous separators may include macro porous polymer, such as polyester. The porous separators include materials of high hydrophilicity and high permeability to water or to the liquid they are designed to sterilize. In one embodiment, the porous separators include water-penetrable insulating media.

In some embodiments, materials for the porous electrodes are selected such that they are hydrophilic or have a high permeability to water or to the liquid they are designed to sterilize.

The disclosed technology may be employed with other power sources and waveforms. For example, the disclosed technology may be employed with the power sources and waveforms described in related U.S. patent application Ser. No. TBD, filed concurrently herewith, entitled “WATER DISINFECTION DEVICES AND METHODS”, Attorney Docket No. 63NL-320179, the disclosure thereof incorporated by reference herein in its entirety.

The foregoing description of the present invention has been provided for the purposes of illustration and description. It is not intended to be exhaustive or to limit the invention to the precise forms disclosed. The breadth and scope of the present invention should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. An apparatus comprising:
a water filtering module including:
a rolled stack of sheets, the sheets comprising:
an electrode sheet comprising a plurality of porous planar electrodes,
a separator sheet comprising a porous planar separator, wherein the porous planar separator is disposed between at least two of the porous planar electrodes, and
a perforated pipe extending longitudinally through a center of the rolled stack of sheets; and
a case configured to house the rolled stack of sheets, and to direct water through the rolled stack of sheets.

2. The apparatus of claim 1, further comprising:
a power source configured to supply power to the at least two porous planar electrodes.

3. The apparatus of claim 1, wherein:
the case is configured to direct the water from an outside of the rolled stack of sheets, through the rolled stack of sheets, to the perforated pipe, and from the perforated pipe to an outlet of the case.

4. The apparatus of claim 1, wherein:
the case is configured to direct the water from an inlet of the case into the perforated pipe, from the perforated pipe through the rolled stack of sheets to an outside of the rolled stack of sheets, and then to an outlet of the case.

5. The apparatus of claim 1, wherein:
the perforated pipe has an inlet section configured to receive water entering an inlet of the case, and an outlet section to direct water to an outlet of the case; and
the case is configured to direct the water from the inlet section of the perforated pipe through a first portion of the rolled stack of sheets to an outside of the rolled stack of sheets, then from the outside of the rolled stack of sheets through a second portion of the rolled stack of sheets into the outlet section of the perforated pipe.

6. The apparatus of claim 1, wherein:
the porous planar electrodes that are adjacent on the electrode sheet are disposed in separate layers of the rolled stack of sheets.

7. The apparatus of claim 1, wherein:
each of the porous planar electrodes includes an elongated pin configured to connect to a power source.

8. The apparatus of claim 7, wherein:
the elongated pins of porous planar electrodes that are adjacent on the electrode sheet are disposed on opposite sides of the electrode sheet.

9. The apparatus of claim 1, wherein:
the porous planar electrodes are made of titanium foil.

10. An apparatus comprising:
a water filtering module including:
a rolled stack of sheets, the sheets comprising:
an electrode sheet comprising a plurality of planar electrodes, and
a separator sheet comprising a planar separator, wherein the planar separator is disposed between at least two of the planar electrodes; and
a case configured to house the rolled stack of sheets, and to direct water between the sheets in the rolled stack of sheets.

11. The apparatus of claim 10, further comprising:
a power source configured to supply power to the planar electrodes.

12. The apparatus of claim 10, wherein:
the rolled stack of sheets is rolled in a spiral configuration, and
the case is configured to direct water between the sheets in a spiral direction.

13. The apparatus of claim 10, wherein:
the case is configured to direct water between the sheets in a longitudinal direction.

14. The apparatus of claim 10, wherein:
the planar electrodes are made of titanium foil.

15. An apparatus comprising:
a water filtering module including:
a plurality of planar electrodes, and
a case configured to retain the electrodes in parallel, and to direct water between the planar electrodes from an inlet of the case to an outlet of the case.

16. The apparatus of claim 15, further comprising:
a power source configured to supply power to the plurality of planar electrodes.

17. The apparatus of claim 15, wherein the planar electrodes are each made of at least one of:
brass;
bronze;
copper;
graphite;
carbon felt;
carbon mesh;
titanium;
stainless steel;
platinum; or
silicon.

18. An apparatus comprising:
a water filtering module including:
a first electrode comprising a plurality of first parallel blades,
a second electrode comprising a plurality of second parallel blades, and
a case configured to retain the electrodes such that the first parallel blades are interleaved with the second parallel blades, and to direct water between the first and second parallel blades.

19. The apparatus of claim 18, further comprising:
a power source configured to supply power to the first and second electrodes.

20. The apparatus of claim 18, wherein:
the first electrode is a first folded sheet; and
the second electrode is a second folded sheet.

21. The apparatus of claim 18, wherein the first and second electrodes are each made of at least one of:
brass;
bronze;
copper;
graphite;
carbon felt;
carbon mesh;
titanium;
stainless steel;
platinum; or
silicon.

22. The apparatus of claim 15, wherein:
each of the planar electrodes is disposed within a respective frame, and the frames are stacked to form a stack.

23. The apparatus of claim 15, wherein:
each of the planar electrodes is molded within a respective frame, and the frames are stacked to form a stack.
